(19) United States
(12) Patent Application Publication
(10) Pub. No.: US 2016/0011585 A1
(43) Pub. Date: Jan. 14, 2016

(54) SYSTEM AND METHOD FOR MANAGING INDUSTRIAL PROCESSES

(71) Applicant: SCHNEIDER ELECTRIC USA, INC., Palatine, IL (US)

(72) Inventors: Aurelien Le Sant, Melrose, MA (US); Christopher Carey Wilkins, Haverhill, MA (US)

(21) Appl. No.: 14/772,573

(22) PCT Filed: Mar. 5, 2013
(86) PCT No.: PCT/US2013/029073

§ 371 Date: Sep. 3, 2015

(51) Int. Cl. G05B 19/418

(52) U.S. Cl. CPC G05B 19/4185; G05B 2219/33149

(57) ABSTRACT

Various embodiments comprise an automatic control device configured to provide information. The automatic control device includes a memory, at least one processor coupled to the memory, an industrial protocol interface executed by the at least one processor and configured to exchange messages formatted according to the industrial protocol. The automatic control device includes a publishing component executed by the at least one processor and configured to receive, from an external device, a subscription request, access information relating to the automatic control device, detect changes in the information, and provide, to the external device, responsive to the detection, the information relating to the automatic control device.

### BACKGROUND

1. Technical Field

The technical field of this disclosure relates generally to control systems and, more particularly, to systems and methods that provide access to information regarding the operation of automatic control devices.

2. Background Discussion

An industrial control system often includes a programmable logic controller (PLC) for providing coordinated control of industrial control equipment. Examples of industrial control equipment include sensors for providing inputs to the PLC or relays for receiving outputs from the PLC, each under the control of an element controller, and each connected to the PLC over a network via a network I/O device. Industrial control using a PLC typically requires what is termed rapid scanning, meaning the continuous, rapid execution by the PLC of three main steps executed repeatedly: the acquiring of the status of each input to the PLC needed to execute so-called ladder logic for the process being controlled, the solving of the ladder logic to determine each output, and the updating of the status of the outputs. For predictable and effective industrial control, a PLC scans the connected I/O devices at a constant scan rate, and avoids becoming so involved in peripheral tasks as to depart from its regularly scheduled monitoring of the I/O devices.

The term ladder logic is used to indicate, in a form recognizable to early workers in the field of machine control, the expression of how the control elements of an industrial control system are to be controlled based on the monitoring elements of the industrial control system. The term ladder is used because the expression of the control logic is actually often in the form of a ladder, with each rung of the ladder having an output, i.e. a value for the required state of a control element, and one or more inputs, i.e. values corresponding to signals from monitoring elements.

Ordinarily, process operation is monitored, at least intermittently, by supervisory personnel via one or more central management stations. Each station samples the status of PLCs (and their associated sensors) selected by the operator and presents the data in some meaningful format. The management station may or may not be located on the same site as the monitored equipment; frequently, one central station has access to multiple sites (whether or not these perform related processes). Accordingly, communication linkage can be vital even in traditional industrial environments where process equipment is physically proximate, since at least some supervisory personnel may not be.

To facilitate the necessary communication, the PLCs and related monitoring stations are connected by a computer network. Typically, a network is organized such that any computer may communicate with any other network computer. The communication protocol provides a mechanism by which messages can be decomposed and routed to a destination computer identified by some form of address. The protocol may place a “header” of routing information on each component of a message that specifies source and destination addresses, and identifies the component to facilitate later reconstruction of the entire message by the destination computer. This approach to data transfer permits the network to rapidly and efficiently handle large communication volumes without reducing transfer speed in order to accommodate long individual messages, or requiring every network computer to process every network message. The degree of routing depends on the size of the network. Each computer of a local network typically examines the header of every message to detect matches to that computer's identifier; multiple-network systems use routing information to first direct message components to the proper network.

### SUMMARY

Various embodiments comprise an automatic control device configured to provide information. The automatic control device includes a memory, at least one processor coupled to the memory, an industrial protocol interface executed by the at least one processor and configured to exchange messages formatted according to the industrial protocol.

In some embodiments, the automatic control device includes a publishing component executed by the at least one processor and configured to receive, from an external device, a subscription request, access information relating to the automatic control device, detect changes in the information, and provide, to the external device, responsive to the detection, the information relating to the automatic control device.

In some embodiments, the information includes data descriptive of one or more industrial processes managed by the automatic control device. In some embodiments, the information includes event notifications.

In some embodiments, the subscription request includes a requested subset of the information relating to the automatic control device.

In some embodiments, the data descriptive of one or more industrial processes managed by the automatic control device comprises one or more measured variables pertaining to the one or more industrial processes. In some embodiments, the changes in the information include a change in one or more variables greater than a configurable threshold.

In some embodiments, the publishing component provides to the external device a subset of the information. In some embodiments, the subset of the information comprises the detected changes in the information.

In some embodiments, the information is provided as an unconverted data stream.

In some embodiments, the publishing component is further configured to provide, responsive to the subscription request, an initial set of the information relating to the automatic control device.

Aspects also include a method of providing information from an automatic control device, the method including receiving, from an external device, a subscription request, accessing information relating to the automatic control device, detecting changes in the information, and providing, to the external device, responsive to the detecting, the information relating to the automatic control device.

Automatic control devices may include any other equipment related at an automatic control application. Examples of automatic control devices that may implement the publishing interface include input/output components, regulation devices, monitoring and control stations, man-machine dialogue terminals, intelligent sensor/actuators and PLCs, such as the PLC 10a described in U.S. Pat. No. 6,640,140, entitled PLC EXECUTIVE WITH INTEGRATED WEB SERVER, issued Oct. 28, 2003, which is hereby incorporated by reference herein in its entirety.

Other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment or example.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic diagram including an exemplary automation monitoring system;

FIG. 2 is a schematic diagram of an exemplary automatic control device;

FIG. 3 is a schematic diagram of an exemplary computer system that may be configured to perform processes and functions disclosed herein; and

FIG. 4 is a flow diagram illustrating a process of publishing information regarding one or more automatic control devices via a publishing component.

### DETAILED DESCRIPTION

At least some embodiments disclosed herein include apparatus and processes for providing, by an automatic control device, information regarding one or more automatic control devices via a publishing component. The publishing component can receive a subscription request from an external device and provide information to the external device based on the subscription request. The automatic control device (“ACD”) information may include one or more identifiers of the automatic control device, such as a device name or internet protocol (“IP”) address, a current state of the device, diagnostic information that may be used to determine how the device entered its current state, ladder logic that the device is configured to execute, configuration management information pertinent to the device, such as hardware and software version information, and historical information regarding the device. Additional examples of ACD information provided by the automatic control device include data descriptive of one or more industrial processes managed by the automatic control device. In one embodiment, this industrial process information is stored as one or more variables disposed within one or more tables, although other logical data structures may be employed without departing from the scope of embodiments disclosed herein. In some embodiments, ACD information is stored within local memory or other data storage included within the automatic control device. In at least one embodiment, the automatic control device provides ACD information via a publishing component of a web server local to the automatic control device. In other embodiments, the automatic control device provides ACD information to one or more other automatic control devices that, in turn, provide the ACD information via a publishing component.

In another embodiment, ACD information is provided to a computer system that is in data communication with an automatic control device via a local network. In this example, the computer system presents an interface through which the computer system receives ACD information for the automatic control device. Responsive to receiving this ACD information, the computer system provides the ACD information to an external device based on changes in the ACD information.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Automation Control System

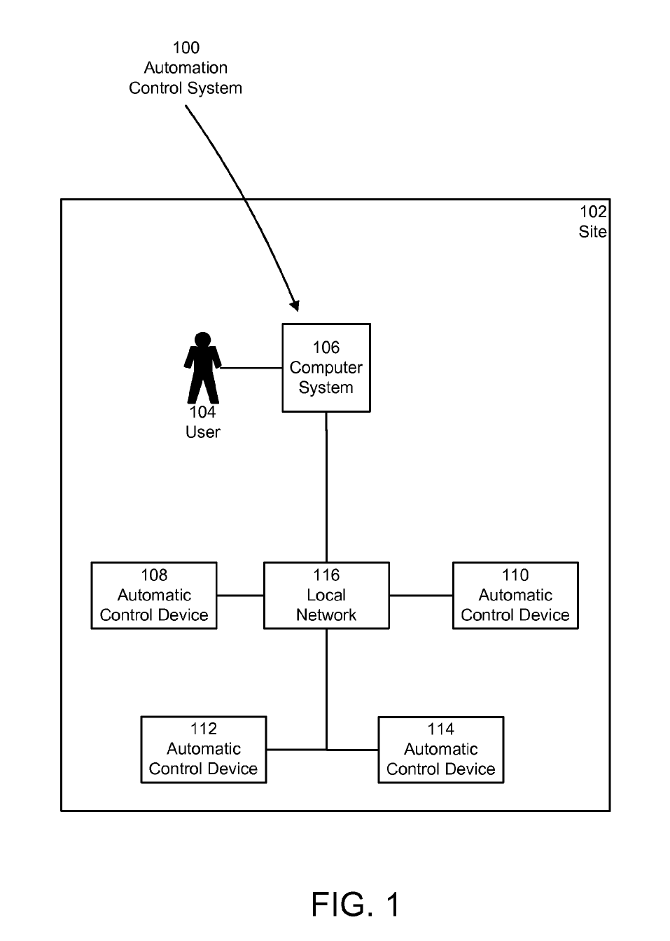

Some embodiments implement an automation control system that provides device and process monitoring via a publishing interface. FIG. 1 illustrates an automation control system 100 that may implement the publishing interface. As shown in FIG. 1, the automation control system 100 includes a computing system 106, automatic control devices 108, 110, 112, and 114, and a local communication network 116. The automation control system 100 and a user 104 of the computer system 106 are located within a site 102.

As shown in FIG. 1, the computer system 106 and the automatic control devices 108, 110, 112, and 114 exchange (i.e. send or receive) information with one another via the network 116. This information may include ACD information, which is described above. In addition, the information exchanged via the network 116 may include other information such as data summarized from ACD information or information used to render a user interface within a browser, among other information.

The network 116 shown in FIG. 1 may include any network through which computer systems communicate data with one another. For example, the communication network may be (or be a part of) a public network, such as the internet, and may include other public or private networks such as LANs, WANs, extranets, and intranets. Alternatively, the network 116 may be an Ethernet LAN running MODBUS over TCP/IP. It is to be appreciated that, in some embodiments, the network 116 includes security features that prevent unauthorized access to the network 116. In these embodiments, the computer system 106 is required to provide valid credentials prior to gaining access to the network 116.

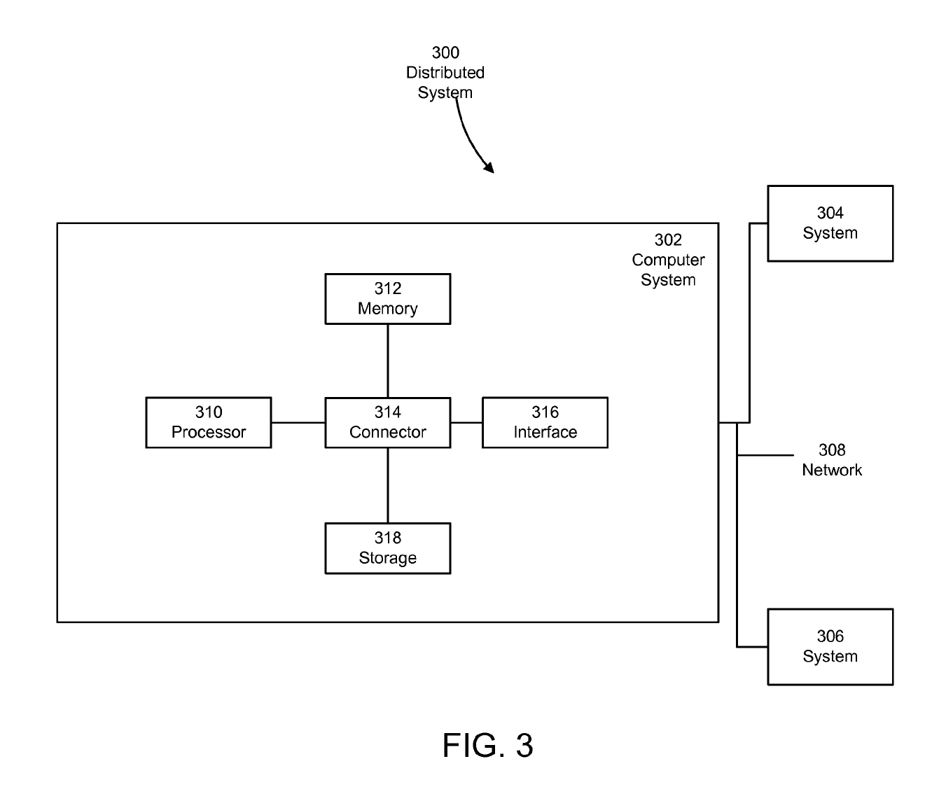

Various embodiments illustrated by FIG. 1 employ a variety of equipment and technology. For instance, in one embodiment, the computer system 106 and the network 116 each include one or more computer systems as described further below with reference to FIG. 3. Thus, the computer system 106 may be a desktop computer, laptop computer, or smart phone. In addition, the automatic control devices 108, 110, 112, and 114 shown in FIG. 1 are specialized computing devices that are specifically configured to control one or more industrial processes.

In some embodiments, the automatic control devices 108, 110, 112, and 114 include one or more components illustrated in FIG. 3, such as one or more processors, interfaces, memory or other data storage, or connectors, such as one or more busses. Furthermore, in a variety of embodiments, these and other automatic control devices communicate using a variety of industrial protocols including MODBUS, UMAS, BACnet, LON, C-BUS™, DMX512 and JCI-N2, and wireless protocols, such as ZigBee and Bluetooth. In the embodiment illustrated in FIG. 1, the automatic control devices 108, 110, 112, and 114 transmit ACD information over the network 126 using the WebSocket protocol.

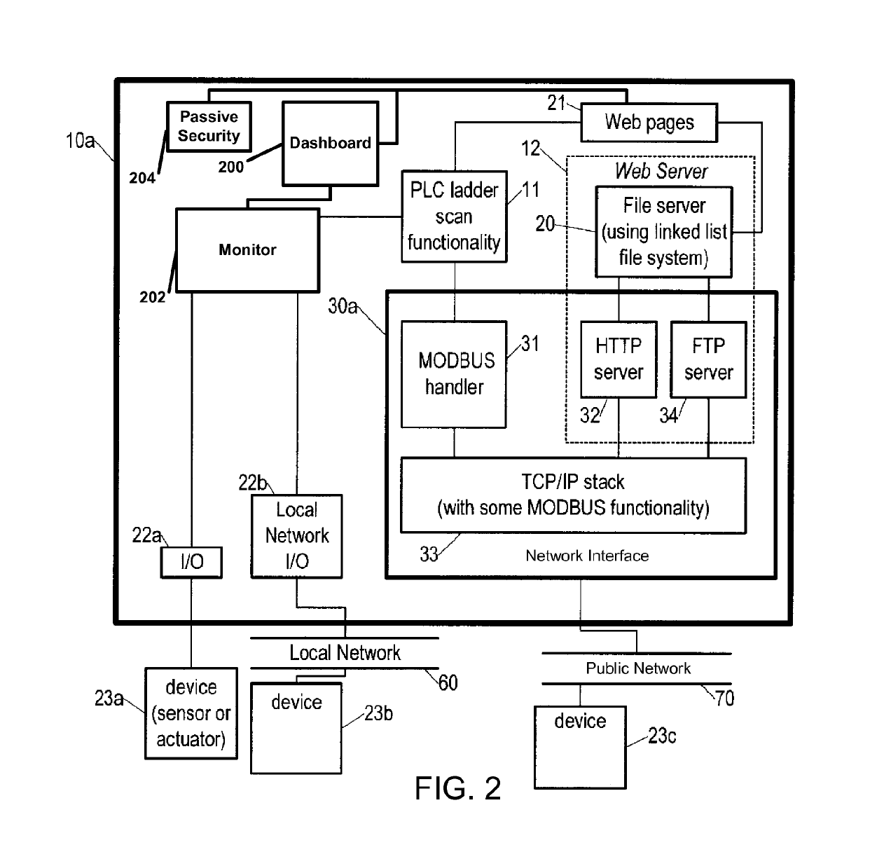

FIG. 2 further illustrates components that may be implemented within any of the automatic control devices 108, 110, 112, and 114. The components illustrated in FIG. 2 may be hardware components, software components or a combination of hardware and software components. In addition, the components illustrated in FIG. 2 may utilize a variety of protocols and standards, such as any of those described with reference to FIG. 3.

As shown in FIG. 2, an exemplary PLC 10a includes a process control component 11 having ladder scan functionality, and a web server component 12. In this example, the process control component 11 services I/O components 22a and 22b. I/O components 22a and 22b are coupled to and in data communication with devices 23a and 23b, such as a wired or wireless network. According to this example, devices 23a and 23b are used by the PLC 10a to control one or more industrial processes. Thus devices 23a and 23b may be any of several types of devices including one or more sensors or actuators.

In the example illustrated in FIG. 2, the process control component 11 executes ladder logic to determine device commands that, when executed by a device, cause the device to enter a predefined state or execute a predefined function. The device commands generated as a result of execution of the ladder logic may depend on inputs received from any devices or sensors within the PLC 10a or received from any devices or sensors in communication with the PLC 10a. While the process control component 11 executes process control logic written using ladder logic, other embodiments may execute programs written using other programming languages. Examples of such programming languages include sequential function charts, function block diagrams, structured text, instruction lists, and 984LL. Thus exemplary ACDs are not required to execute programs written using a particular programming language.

The devices that are controlled by the PLC 10a or in data communication with the PLC 10a can be coupled to the PLC 10a either directly (as is the device 23a), by a local network 60 (as is the device 23b), or by the public network 70 (as is the device 23c). In the case of the device 23c connected to the PLC 10a via the public network 70, the PLC 10a uses a network interface 30a to process input and output associated with the device 23c. The network interface includes a MODBUS handler 31 and a transmission control program (TCP)/Internet protocol (IP) stack 33 having some MODBUS functionality (as further described below) and providing for communication over the public network 70 according to TCP/IP.

The terminology MODBUS refers here to a family of simple, vendor-neutral communication protocols intended for supervision and control of automation equipment. In the example illustrated in FIG. 2, the TCP/IP stack is MODBUS/TCP compliant. MODBUS/TCP is a member of the family of MODBUS protocols, and MODBUS/TCP supports the use of MODBUS messaging in a networking environment using TCP/IP protocols. In some examples, the public network interface 30a is based on MODBUS TCP/IP, as defined by the Open MODBUS/TCP specification, release 1.0, which is hereby incorporated herein by reference in its entirety. The specification defines how MODBUS commands and responses are delivered over the Internet to and from a MODBUS server using the well known port 502. In the example of FIG. 2, the TCP/IP stack 33 is a custom stack and is programmed to process any MODBUS command or message as a single packet, optimizing all MODBUS communications.

As shown in FIG. 2, the web server 12 includes both a file server 20, which may use a linked list file system, and a hypertext transfer protocol (“HTTP”) server 32, i.e., a component for communicating hypertext (used to describe a web page to a browser so that the browser can display the web page) according to HTTP. The HTTP server 32 also includes a publishing component 200, which provides information to a browser based on changes in the information. The publishing component 200 is described in further detail below. In the example shown in FIG. 2, the web server 12 also includes a file transfer protocol (“FTP”) server 34 that accepts downloads of new or replacement web pages or other files and provides them to the file server 20. In this example, the TCP/IP stack 33 determines whether an incoming message (TCP/IP packet) is for the MODBUS handler 31, the HTTP server 32, or the FTP server 34 based on the port number specified in the incoming message.

In some embodiments, each of the automatic control devices 108, 110, 112, and 114 is configured to publish ACD information regarding itself and the industrial processes the devices manage. For example, the automatic control devices 108, 110, 112, 114 can provide ACD information based on changes in the ACD information. The automatic control devices 108, 110, 112, 114 can push data to external devices when values of the data changes.

In some embodiments, the automatic control devices 108, 110, 112, and 114 provide a user interface through which the automatic control devices receive configuration information. In these embodiments, this configuration information specifies how the automatic control devices are to publish ACD information. For instance, the configuration information may describe events of importance that cause the automatic control devices to publish ACD information, may specify a publication period to be followed by the automatic control devices, may specify an identifier, such as an IP address, of one or more automatic control devices to which ACD information should be published, or may specify characteristics of the display of ACD information. In some embodiments, the automatic control devices 108, 110, 112, and 114 serve this user interface to browsers via a web server resident on the automatic control devices, such as the web server 12 described above with reference to FIG. 2.

Information within the components of the automation control systems 100 may be stored in any logical construction capable of holding information on a computer readable medium including, among other structures, file systems, flat files, indexed files, hierarchical databases, relational databases, or object oriented databases. The data may be modeled using unique and foreign key relationships and indexes. The unique and foreign key relationships and indexes may be established between the various fields and tables to ensure both data integrity and data interchange performance.

Information may flow between the components of the automation control system 100, or any of the elements, components and subsystems disclosed herein, using a variety of techniques. Such techniques include, for example, passing the information over a network using standard protocols, such as TCP/IP or HTTP, passing the information between components or other components in memory and passing the information by writing to a file, database, data store, or some other non-volatile data storage device. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

Embodiments of the automation control system 100 are not limited to the particular configuration illustrated in FIG. 1. Various embodiments utilize a variety of hardware components, software components and combinations of hardware and software components configured to perform the processes and functions described herein. As discussed above, in some embodiments, the automation control system 100 are implemented using one or more computer systems, such as the computer systems described further below with regard to FIG. 3.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 3, there is illustrated a block diagram of a distributed computer system 300, in which various aspects and functions are practiced. As shown, the distributed computer system 300 includes one more computer systems that exchange information. More specifically, the distributed computer system 300 includes computer systems 302, 304 and 306. As shown, the computer systems 302, 304 and 306 are interconnected by, and may exchange data through, a communication network 308. The network 308 may include any communication network through which computer systems may exchange data. To exchange data using the network 308, the computer systems 302, 304 and 306 and the network 308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, Jquery, Web Services, and WebSockets. To ensure data transfer is secure, the computer systems 302, 304 and 306 may transmit data via the network 308 using a variety of security measures including, for example, TLS, SSL or VPN. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, a connector 314, an interface 316 and data storage 318. To implement at least some of the aspects, functions and processes disclosed herein, the processor 310 performs a series of instructions that result in manipulated data. The processor 310 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. The processor 310 is connected to other system components, including one or more memory devices 312, by the connector 314.

The memory 312 stores programs and data during operation of the computer system 302. Thus, the memory 312 may be a relatively high performance, volatile, random access memory such as a dynamic random access memory (DRAM) or static memory (SRAM). However, the memory 312 may include any device for storing data, such as a disk drive or other non-volatile storage device. Various examples may organize the memory 312 into particularized and, in some cases, unique structures to perform the functions disclosed herein. These data structures may be sized and organized to store values for particular data and types of data.

Components of the computer system 302 are coupled by an interconnection element such as the connector 314. The connector 314 may include one or more physical busses, for example, busses between components that are integrated within a same machine, but may include any communication coupling between system elements including specialized or standard computing bus technologies such as IDE, SCSI, PCI and InfiniBand. The connector 314 enables communications, such as data and instructions, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage 318 includes a computer readable and writeable nonvolatile, or non-transitory, data storage medium in which instructions are stored that define a program or other object that is executed by the processor 310. The data storage 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller causes data to be read from the nonvolatile recording medium into another memory, such as the memory 312, that allows for faster access to the information by the processor 310 than does the storage medium included in the data storage 318. The memory may be located in the data storage 318 or in the memory 312, however, the processor 310 manipulates the data within the memory, and then copies the data to the storage medium associated with the data storage 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Automation Control System Processes

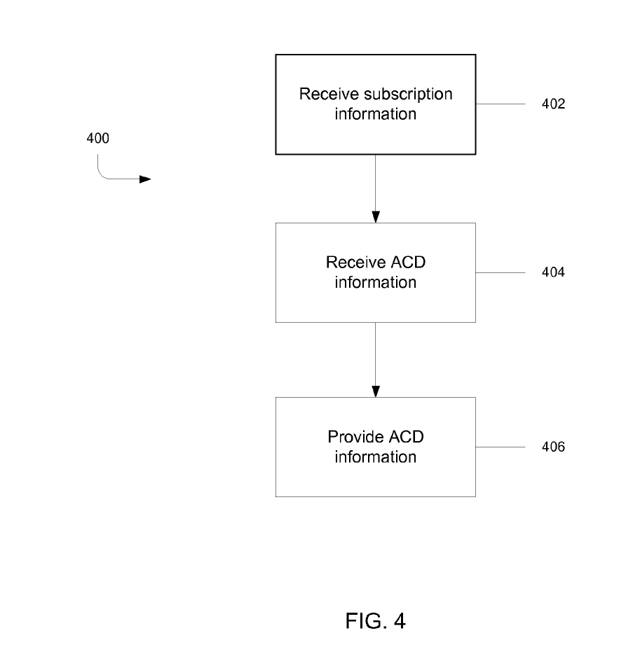

As described above with reference to FIG. 1, several embodiments perform publishing processes that publish ACD information via a publishing component 200. In some embodiments, the publishing component 200 is included in the web server 12 described above with reference to FIG. 2. One example of a publishing process is illustrated in FIG. 4. According to this example, the publishing process 400 includes acts of receiving a subscription request, receiving ACD information, and providing ACD information via the publishing component 200.

In act 402, the publishing component 200 receives a subscription request from an external device. The external device can be any appropriate computing device with communication capability. For example, the external device can be one of the example computer systems describe above with reference to FIG. 3. The external device can communicate with the automation control system 100 using one or more of the protocols described above. For example, the publishing component 200 can be included in the web server 12 of the automation control device. The subscription request can be generated by a web browser on the external device using the WebSocket protocol (e.g., as available in HTML5).

The subscription request can include information identifying specific subset variables and/or events of interest to the user. Alternatively or additionally, the subscription request can request all available ACD information. The values of the variables may represent a variety of physical measurements and other information that are used as inputs to the process control logic executed by an automatic control device or that are provided as outputs resulting from the execution of the process control logic. Examples of this process control logic include, for example, ladder logic as described above. Examples of the physical phenomenon represented by variables include temperature, light levels, power levels, weight, and humidity. Events can include actions taken or requested on the ACD. For example, a shutdown request of the ACD can be considered an event. Events can also include problems or alarm conditions detected on the ACD. Events can also include detected changes in the environment or processes and/or equipment controlled by the ACD.

In act 404, the publishing component receives ACD information from one of a variety of sources, such as a sensor coupled to the automatic control device, a user interface provided by the automatic control device, or an automatic control device distinct from the automatic control device executing the publishing component. Examples of the ACD information received include information posted by site personnel via the user interface and information descriptive of one or more industrial processes managed by the automatic control device or other, distinct automatic control devices. ACD information also includes variable values and event notifications.

In act 406, the publishing component provides ACD information to the external device. In some embodiments, the publishing component provides ACD information to the external device when the information changes. For example, the ACD information can include thousands of variables for which the values can change at varying rates. Some of the variables can have values that do not change frequently, while other variables can have values that change relatively often. The publishing component can compare the next received set of ACD information and compare the most recent ACD information with the previous ACD information. If no information has changed, the publishing component can wait to receive the next set of ACD information. If information has changed, the publishing component can provide the ACD information to the external device. In some embodiments, the publishing component provides all the requested ACD information on change of any portion of the ACD information. In other embodiments, the publishing component provides only the requested ACD information that has changed. In some embodiments, the publishing component can also provide an indication that the ACD information has not changed, for example, to verify that the communication channel has not been closed.

Thus, rather than an external device polling the automatic control system at some interval for ACD information, the publishing component can push data to the external device when the publishing component determines that a data change of interest has occurred. The publishing component can determine that a data change is of interest depending on the variables and events for which the external device has subscribed. The publishing component can also determine that a data change is of interest depending on a degree of change. For example, the publishing component can be configured to publish changes if the changes exceed a threshold amount. IN some embodiments, the publishing component is implemented using the HTML5 standard.

In some embodiments, the automatic control system can receive and provide ACD information directly in a binary format. For example, the publishing component can provide the ACD data without wrapping the data in a protocol such as XML or other format. The publishing component can provide the data directly to the external device, which can format t the data accordingly. The publishing component and the external device can save processing resources as the data does not need to be converted to or wrapped in different formats.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. An automatic control device configured to provide information, the automatic control device comprising:
a memory;
at least one processor coupled to the memory;
an industrial protocol interface executed by the at least one processor and configured to exchange messages formatted according to the industrial protocol; and
a publishing component executed by the at least one processor and configured to:
receive, from an external device, a subscription request;
access information relating to the automatic control device;
detect changes in the information; and
provide, to the external device, responsive to the detection, the information relating to the automatic control device.

2. The automatic control device according to claim 1, wherein the information comprises data descriptive of one or more industrial processes managed by the automatic control device.

3. The automatic control device according to claim 1, wherein the information comprises event notifications.

4. The automatic control device according to claim 1, wherein the subscription request comprises a requested subset of the information relating to the automatic control device.

5. The automatic control device according to claim 2, wherein the data descriptive of one or more industrial processes managed by the automatic control device comprises one or more measured variables pertaining to the one or more industrial processes.

6. The automatic control device according to claim 5, wherein the changes in the information comprise a change in one or more variables greater than a configurable threshold.

7. The automatic control device according to claim 1, wherein the publishing component provides to the external device a subset of the information.

8. The automatic control device according to claim 7, wherein the subset of the information comprises the detected changes in the information.

9. The automatic control device according to claim 1, wherein the information is provided as an unconverted data stream.

10. The automatic control device according to claim 1, wherein the publishing component is further configured to:
provide, responsive to the subscription request, an initial set of the information relating to the automatic control device.

11. A method of providing information from an automatic control device, the method comprising:
receiving, from an external device, a subscription request;
accessing information relating to the automatic control device;
detecting changes in the information; and
providing, to the external device, responsive to the detecting, the information relating to the automatic control device.

12. The method according to claim 11, wherein receiving the information comprises receiving data descriptive of one or more industrial processes managed by the automatic control device.

13. The method according to claim 11, wherein receiving the information comprises receiving event notifications.

14. The method according to claim 11, wherein receiving the subscription request comprises receiving a requested subset of the information relating to the automatic control device.

15. The method according to claim 12, wherein receiving data descriptive of one or more industrial processes managed by the automatic control device comprises receiving one or more measured variables pertaining to the one or more industrial processes.

16. The method according to claim 15, wherein detecting the changes in the information comprises detecting a change in one or more variables greater than a configurable threshold.

17. The method according to claim 11, wherein providing the information comprises providing a subset of the information.

18. The method according to claim 17, wherein providing the subset of the information comprises providing the detected changes in the information.

19. The method according to claim 11, wherein providing the information comprises providing an unconverted data stream.

20. A non-transitory computer readable medium storing sequences of instructions for providing security information including instructions encoded to instruct at least one processor to:
receive, from an external device, a subscription request;
access information relating to the automatic control device;
detect changes in the information; and
provide, to the external device, responsive to the detection, the information relating to the automatic control device.
